(19) United States
(12) Patent Application Publication
(10) Pub. No.: US 2005/0078823 A1
(43) Pub. Date: Apr. 14, 2005

(54) Content recording apparatus, content recording method and hard disk apparatus

(76) Inventors: Makoto Usui, Osaka (JP); Shin-Ichi Tanaka, Kyoto (JP)

Correspondence Address: MARK D. SARALINO (GENERAL);RENNER, OTTO, BOISELLE & SKLAR, LLP, 1621 EUCLID AVENUE, NINETEENTH FLOOR, CLEVELAND, OH, 44115-2191, US

(21) Appl. No.: 10/935,959

(22) Filed: Sep. 8, 2004

(30) Foreign Application Priority Data
Sep. 11, 2003 (JP) 2003-319375

(51) Int. Cl. H04N 7/167

(52) U.S. Cl. 380/201

(57) ABSTRACT

A content recording apparatus is provided, which comprises a content receiving section for receiving contents, a content identifying section for identifying a specific content satisfying specific conditions among the received contents, a plurality of content recording sections configured to record the received contents, and a recording control section for controlling at least two of the plurality of content recording sections to record the specific content.

This non-provisional application claims priority under 35 U.S.C. §119(a) on Patent Application No. 2003-319375 filed in Japan on Sep. 11, 2003, the entire contents of which are hereby incorporated by reference.

### BACKGROUND OF THE INVENTION

1. Field of the Invention

The present invention relates to a content recording apparatus and a content recording method for recording contents (e.g., video data, audio data, etc.) onto recording means. The present invention also relates to a hard disk apparatus comprising a hard disk and a storing section. The present invention is applied to, for example, a hard disk recorder which records contents onto a built-in hard disk and a content backup method.

2. Description of the Related Art

Recently, the advent of high-capacity, high-speed, and low-price hard disks activates the development of a hard disk recorder which records video contents (e.g., television broadcast programs, etc.) onto a hard disk. The high capacity of a hard disk makes it possible to record long hours of TV programs into a hard disk recorder. In addition, due to the random accessibility of a hard disk, contents which you want to play can be found quickly, and various trick plays can be enjoyed. Hard disk recorders having these features are expected to become more and more commonplace.

As a variation of a hard disk recorder, an apparatus having a combination of a hard disk and a recordable medium (e.g., recordable DVD (Digital Versatile Disc)) is being vigorously developed. In this apparatus, before the hard disk is full of contents, only contents that you want to save are dubbed onto the recordable DVD, so that the contents can be retained in the apparatus. It is a cumbersome task for users to choose and back up contents that you want to save. Therefore, a technique of automatically sorting contents and recording the sorted contents into the apparatus while reducing the task of the user has been proposed in, for example, Japanese Laid-Open Publication No. 2003-110988.

Contents (e.g., ground wave digital broadcast programs, etc.) can be digitally recorded at a high transfer rate onto a hard disk in a hard disk recorder, without a reduction in the quality of data. In this case, however, the quality of contents is not degraded by repetition of copying. Therefore, hard disk recorders are configured to prevent unlimited copying by technical means for the protection of copyright. For example, contents are, in principle, encrypted and then transmitted in ground wave digital broadcast. Therefore, audiences insert a CAS card (supplied from BS Conditional Access Systems Co., Ltd.) into a hard disk apparatus to decrypt the encryption in order to watch the ground wave digital broadcast.

Contents often include a copy-limiting signal which “permits copying only once”. Therefore, for example, a method for recording/reproducing contents from a hard disk in a hard disk recorder only when ID information uniquely assigned to the hard disk is correctly recognized, has been proposed in Japanese Laid-Open Publication No. 2003-59180. With this technique, it is possible to prevent unlimited repetition of copying contents using a personal computer which can obtain the contents from a hard disk recorder via an illegal connect.

As the application range of hard disk recorders is expanded, opportunities to record particular contents (e.g., precious contents, pay contents, etc.) onto a hard disk are increased.

As hard disks are becoming widespread as means for recording contents, it is an important challenge to assure the life and reliability of hard disks.

Generally, the life of a hard disk is finite, i.e., about several tens of thousands hours. Hard disks have a high-precision mechanism. Therefore, when a strong impact is applied to a hard disk, the hard disk unavoidably suffers from damage called “crash” on its mechanism. The damage may lead to loss of data recorded in the hard disk.

In the future, among television broadcast systems, BS (Broadcast Satellite) digital broadcast, CS (Communication Satellite) digital broadcast, and ground wave digital broadcast will be mainstream, and most broadcast programs have a limitation on the number of times you can copy them. Pay contents will be typically downloaded via the Internet. When such contents are recorded on a hard disk in a great amount, the loss of the contents due to the failure of a high-capacity hard disk would account for a great amount of money. Therefore, there is an urgent demand for the development of a content recording apparatus which avoid loss of contents.

According to the technique disclosed in Japanese Laid-Open Publication No. 2003-110988, contents can be relatively easily backed up onto a digital videotape, though contents, which have not been backed up, are lost when a hard disk is broken.

Hard disk recorders have penetrated into home, and recording contents onto a hard disk is widely performed. In these situations, it is not reasonable to request users to regularly back up contents onto a digital videotape.

When contents are backed up onto a hard disk instead of a digital videotape, the backup can be relatively easily carried out though another hard disk for backup needs to be prepared by the user.

When contents which permit copying only once are backed up onto a hard disk, the contents need to be deleted from the original hard disk after backing up. As a result, the contents may be lost when the backup hard disk is broken.

When HDTV contents are backed up onto a recordable DVD, the backed up HDTV contents are down-converted to the image quality of the conventional broadcast.

In the technique disclosed in Japanese Laid-Open Publication No. 2003-59180, contents can be recorded onto only a hard disk which has been authenticated with reference to the ID information, thereby making it possible to prevent a personal computer from unlimited copying. However, contents are lost when a hard disk is broken.

### SUMMARY OF THE INVENTION

According to an aspect of the present invention, a content recording apparatus comprises: a content receiving section for receiving contents; a content identifying section for identifying a specific content satisfying specific conditions among the received contents; a plurality of content recording sections configured to record the received contents; and a recording control section for controlling at least two of the plurality of content recording sections to record the specific content.

In one embodiment of this invention, the recording control section may control one of the plurality of content recording sections to record a content different from the specific content.

In one embodiment of this invention, each of the plurality of content recording sections may be a hard disk having a spindle.

In one embodiment of this invention, the recording control section may control a specific content recording section among the plurality of content recording sections but other than the at least two content recording sections, and one of the at least two content recording sections, to record the specific content recorded in the one of the at least two content recording sections into the specific content recording section.

In one embodiment of this invention, the content recording apparatus may further comprise a content specifying section for arbitrarily specifying a content among the received contents.

In one embodiment of this invention, the specific content may be the arbitrarily specified content.

In one embodiment of this invention, the specific content may be a pay content including billing information.

In one embodiment of this invention, the specific content may be a copying-limited content including copying limitation information.

In one embodiment of this invention, the content recording apparatus may further comprise an encryption section for encrypting at least one content among the received contents.

In one embodiment of this invention, the at least one content may be the specific content.

In one embodiment of this invention, the content recording apparatus may further comprise an ID information storing section for storing apparatus ID information for specifying the content recording apparatus. The encryption section may encrypt the at least one content using the apparatus ID information.

In one embodiment of this invention, each of the plurality of content recording sections may further comprise an ID information storing section for storing ID information for encryption. The encryption section may encrypt the at least one content using at least one of the plurality of pieces of ID information.

In one embodiment of this invention, the plurality of pieces of ID information may have the same value as one another.

In one embodiment of this invention, the plurality of pieces of ID information may have different values from one another. The encryption section may encrypt the at least one content using one of the plurality of pieces of ID information.

In one embodiment of this invention, the content recording apparatus may further comprise an authentication section for performing authentication for the plurality of content recording sections. The recording control section may transfer ID information of the plurality of pieces of ID information corresponding to the at least one content recording section from at least one of the plurality of content recording sections to the encryption section based on a result of the authentication.

In one embodiment of this invention, each of the plurality of ID information storing sections may be a card configured to be detachable from the content recording section.

In one embodiment of this invention, each of the plurality of ID information storing sections may be a semiconductor element.

In one embodiment of this invention, each of the plurality of ID information storing section may have a specific storage region, the region being prohibited from recording by the user. Each of the plurality of pieces of ID information may be stored in the specific storage region.

In one embodiment of this invention, the content recording apparatus may further comprise: a connecting section for connecting the content recording apparatus to an external network to obtain information via the external network; and an ID information setting section for setting each of the plurality of pieces of ID information to the information obtained via the external network.

In one embodiment of this invention, the content recording apparatus may further comprise an ID information transmitting section for encrypting the plurality of pieces of ID information and transmitting the plurality of pieces of encrypted ID information to the external network.

According to another aspect of the present invention, a method for recording contents into a plurality of content recording sections configured to record contents, is provided, which comprises the steps of: (a) receiving contents; (b) identifying a specific content satisfying specific conditions among the received contents; and (c) controlling at least two of the plurality of content recording sections to record the specific content.

In one embodiment of this invention, the step of (c) may comprise controlling one of the plurality of content recording sections to record a content different from the specific content.

In one embodiment of this invention, each of the plurality of content recording sections may be a hard disk having a spindle.

In one embodiment of this invention, the step of (c) may comprise controlling a specific content recording section among the plurality of content recording sections but other than the at least two content recording sections, and one of the at least two content recording sections, to record the specific content recorded in the one of the at least two content recording sections into the specific content recording section.

In one embodiment of this invention, the method may further comprise arbitrarily specifying a content among the received contents.

In one embodiment of this invention, the specific content may be the arbitrarily specified content.

In one embodiment of this invention, the specific content may be a pay content including billing information.

In one embodiment of this invention, the specific content may be a copying-limited content including copying limitation information.

In one embodiment of this invention, the method may further comprise encrypting at least one content among the received contents.

In one embodiment of this invention, the at least one content may be the specific content.

In one embodiment of this invention, the method may further comprise storing apparatus ID information for specifying a content recording apparatus comprising the plurality of content recording sections. The encrypting step may comprise encrypting the at least one content using the apparatus ID information.

In one embodiment of this invention, each of the plurality of content recording sections may further comprise an ID information storing section for storing ID information for encryption. The encrypting step may comprise encrypting the at least one content using at least one of the plurality of pieces of ID information.

In one embodiment of this invention, the plurality of pieces of ID information may have the same value as one another.

In one embodiment of this invention, the plurality of pieces of ID information may have different values from one another. The encrypting step may comprise encrypting the at least one content using one of the plurality of pieces of ID information.

In one embodiment of this invention, the method may further comprise performing authentication for the plurality of content recording sections. The step of (c) may comprise transferring ID information of the plurality of pieces of ID information corresponding to the at least one content recording section from at least one of the plurality of content recording sections to an encryption section for performing the encrypting step, based on a result of the authentication.

In one embodiment of this invention, each of the plurality of ID information storing sections may be a card configured to be detachable from the content recording section.

In one embodiment of this invention, each of the plurality of ID information storing sections may be a semiconductor element.

In one embodiment of this invention, each of the plurality of ID information storing section may have a specific storage region, the region being prohibited from recording by the user. Each of the plurality of pieces of ID information may be stored in the specific storage region.

In one embodiment of this invention, the method may further comprise: obtaining information via the external network; and setting each of the plurality of pieces of ID information to the information obtained via the external network.

In one embodiment of this invention, the method may further comprise encrypting the plurality of pieces of ID 20, information and transmitting the plurality of pieces of encrypted ID information to the external network.

According to another aspect of the present invention, a hard disk apparatus is provided, which comprises: a hard disk for recording encrypted information; and a storing section for storing ID information for encryption. The storing section is configured to be detachable from the hard disk apparatus.

In one embodiment of this invention, the hard disk apparatus may be configured to be detachable from a main body. The main body may comprise an encryption/decryption section for encrypting information to be recorded into the hard disk or decrypting encrypted information recorded in the hard disk.

Hereinafter, effects of the present invention will be described.

According to the content recording apparatus and the content recording method of the present invention, a specific content is recorded into at least two content recording sections. Therefore, even if one of the at least two content recording sections (e.g., hard disk units) recording the specific content is broken, it is possible to prevent the specific content from being lost from a content recording apparatus.

According to the content recording apparatus and the content recording method of the present invention, it is possible for the user to back up specific contents (e.g., precious contents, pay contents, etc.) on a day-to-day basis without any particular backup operations. As a result, it is possible to prevent specific contents from being lost due to the failure of a hard disk, and prevent the illegal use of specific contents.

According to the content recording apparatus and the content recording method of the present invention, when a new hard disk is prepared, it is possible to record and restore specific contents onto the new hard disk. The recorded contents are encrypted using ID information which cannot be altered by general users, thereby making it possible to prevent the illegal use of the specific contents using a personal computer or the like.

According to the content recording apparatus and the content recording method of the present invention, a storing section for storing ID information for encryption is configured to be detachable from a hard disk apparatus. Therefore, when a hard disk apparatus is broken and a new hard disk apparatus is used, the user can easily move ID information to the new hard disk apparatus and restore mirrored contents.

Thus, the invention described herein makes possible the advantage of providing a content recording apparatus, a content recording method, and a hard disk apparatus comprising a hard disk and a storing section, in which specific contents are prevented from being lost due to the failure of a hard disk and the illegal copying of specific contents is prevented.

These and other advantages of the present invention will become apparent to those skilled in the art upon reading and understanding the following detailed description with reference to the accompanying figures.

### BRIEF DESCRIPTION OF THE DRAWINGS

FIG. 1 shows a configuration of a content recording apparatus according to Embodiment 1 of the present invention.

FIG. 2 shows a flow of a recording operation according to Embodiment 1 of the present invention.

FIG. 3 shows a flow of a content restoring operation according to Embodiment 1 of the present invention.

FIG. 4 shows a display screen included in a content specifying section.

FIG. 5 shows a configuration of a content recording apparatus according to Embodiment 2 of the present invention.

FIG. 6 shows a flow of a recording operation according to Embodiment 2 of the present invention.

FIG. 7 shows a configuration of a content recording apparatus according to Embodiment 3 of the present invention.

FIG. 8 shows a flow of a recording operation according to Embodiment 3 of the present invention.

FIG. 9 shows a configuration of a hard disk unit according to Embodiment 3 of the present invention.

FIG. 10 shows a hard disk unit according to Embodiment 3 of the present invention.

FIG. 11 shows a configuration of a hard disk unit according to Embodiment 3 of the present invention.

FIG. 12 shows a configuration of a content recording apparatus according to Embodiment 4 of the present invention.

### DESCRIPTION OF THE PREFERRED EMBODIMENTS

Hereinafter, the present invention will be described by way of illustrative examples with reference to the accompanying drawings.

(Embodiment 1)

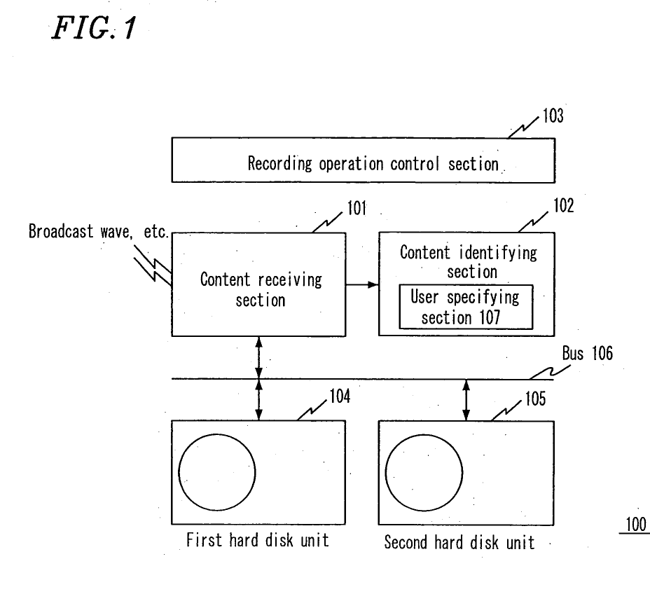

FIG. 1 shows a configuration of a content recording apparatus 100 according to Embodiment 1 of the present invention.

The content recording apparatus 100 comprises a content receiving section 101, a content identifying section 102, a first hard disk unit 104, a second hard disk unit 105, a recording operation control section 103, a bus 106, and a user specifying section 107.

The content receiving section 101 receives contents. The content receiving section 101 is, for example, a tuner or an interface circuit which receives television broadcast signals.

The content identifying section 102 identifies a specific content which satisfies specific conditions. For this purpose, for example, the content identifying section 102 determines whether or not a received content satisfies identification conditions (specific conditions). When the received content satisfies the identification conditions, the content identifying section 102 identifies the received content as a specific content. When the received content does not satisfy the identification conditions, the content identifying section 102 determines that the received content is different from the specific content.

A specific content may be, for example, a pay content including billing information. In order to identify a received content as a pay content, the content identifying section 102 determines whether or not the received content include billing information.

A specific content may be, for example, a copying-limited content including copying limitation information. In order to identify a received content as a copying-limited content, the content identifying section 102 determines whether or not the received content includes copying limitation information.

A specific content may be, for example, a content which is broadcast along with an identification flag. In order to identify a received content as such a content, the content identifying section 102 determines whether or not an identification flag is attached to the received content.

A specific content may be, for example, a content which has been recorded on a hard disk for a predetermined period of time without deletion. In order to identify a received content as such a content, the content identifying section 102 determines whether or not the received content has been recorded for a predetermined period of time, with reference to a time stamp of the received content.

A specific content may be, for example, a file having a specific extension. In order to identify a received content as a file having a specific extension, the content identifying section 102 determines whether or not the received content has the specific extension.

A specific content may be, for example, a file including management information. The management information is used to manage a file(s) stored in a hard disk. In order to identify a received content as a file including management information, the content identifying section 102 determines whether or not the received content includes management information.

A specific content may be, for example, a content arbitrarily specified by the user. In order to identify a received content as such an arbitrarily specified content, the content identifying section 102 determines whether or not the received content is specified by the user. Examples of a content arbitrarily specified by the user include, but are not limited to, contents of a genre specified by the user, contents recorded in a directory specified by the user, and the like.

The user arbitrarily specifies a content by operating the user specifying section 107. The user specifying section 107 will be described in more detail below.

The first hard disk unit 104 and the second hard disk unit 105 are configured to record contents. The first hard disk unit 104 and the second hard disk unit 105 are each, for example, a hard disk having a spindle.

The recording operation control section 103 controls components of the content recording apparatus 100. The recording operation control section 103 controls the first hard disk unit 104 and the second hard disk unit 105, for example, in a manner which causes these hard disks to record a specific content. The recording operation control section 103 also controls one of the first hard disk unit 104 and the second hard disk unit 105 in a manner which causes the one hard disk to record a content different from the specific content.

The content receiving section 101, the first hard disk unit 104 and the second hard disk unit 105 are connected to the bus 106.

The content recording apparatus 100 according to Embodiment 1 of the present invention has been described with reference to FIG. 1.

In the example of FIG. 1, the content receiving section 101 corresponds to a “content receiving section for receiving a content”; the content identifying section 102 corresponds to a “specific content identifying section for identifying a content as a specific content which satisfies specific conditions”; the first hard disk unit 104 and the second hard disk unit 105 correspond to “a plurality of content recording sections each configured to record a content”; and the recording operation control section 103 corresponds to a “recording control section for controlling at least two content recording sections among a plurality of content recording sections to record a specific content”. However, the example of FIG. 1 shows only one exemplary configuration of the content recording apparatus 100 according to according to Embodiment 1 of the present invention. As long as the functions of the above-described sections can be achieved, a content recording apparatus having any configuration falls within the scope of the present invention. For example, the functions of the above-described sections may be implemented either as hardware or as software, or as a combination of hardware and software.

For example, the content recording apparatus 100 may comprise a CPU and a storing section which stores a recording operation program for causing the CPU to execute a recording operation. A flow of the recording operation will be described in detail below.

The recording operation program may be stored in the storing section in advance before the content recording apparatus 100 is shipped from a factory. Alternatively, after shipment of the content recording apparatus 100, the recording operation program may be stored into the storing section. For example, the user may download the recording operation program from a specific website on the Internet at a charge or at no charge, and install the downloaded program into the content recording apparatus 100. When the recording operation program is recorded on a computer readable recording medium, such as a flexible disc, a CD-ROM, a DVD-ROM, or the like, the recording operation program may be installed via an input apparatus (e.g., a disc drive apparatus, etc.) into the content recording apparatus 100. The installed program is stored in the storing section.

Note that the content recording apparatus 100 may comprise at least one hard disk unit in addition to the first hard disk unit 104 and the second hard disk unit 105. For example, these hard disk units can be separately detached from the content recording apparatus 100. For example, these hard disk units may be each comprised of another storage medium, such as an optical disc or the like.

When the content recording apparatus 100 comprises a plurality of hard disk units, the recording operation control section 103 controls at least two hard disk units among the plurality of hard disk units to record a specific content. The recording operation control section 103 also controls one of the plurality of hard disk units in a manner which records a content different from the specific content.

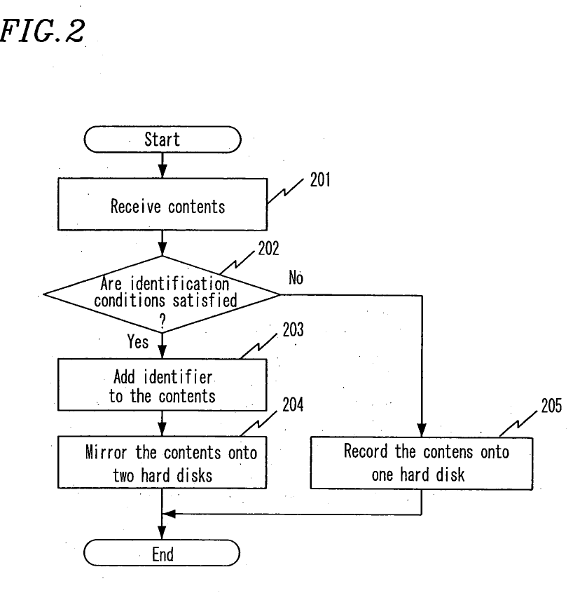

FIG. 2 shows a flow of the recording operation according to Embodiment 1 of the present invention. This flow of the recording operation is carried out by, for example, the content recording apparatus 100.

Hereinafter, the recording operation flow will be described step by step with reference to FIGS. 1 and 2.

Step 201: the content receiving section 101 receives contents.

Step 202: the content identifying section 102 determines whether or not each of the received contents satisfies identification conditions (specific conditions), in order to identify a specific content among the received contents.

When a content satisfies the identification conditions (Yes), the content identifying section 102 identifies the content as the specific content. The process goes to step 203. When it is determined that a content does not satisfy the identification conditions (No), the content identifying section 102 identifies the content as a content different from the specific content. The process goes to step 205.

Step 203: the recording operation control section 103 attaches an identifier to the specific content.

Step 204: the recording operation control section 103 controls the first hard disk unit 104 and the second hard disk unit 105 in a manner such that the specific content is mirrored. Thereafter, the process is ended. Note that the identifier will be described in more detail below.

Step 205: the recording operation control section 103 controls one of the first hard disk unit 104 and the second hard disk unit 105 in a manner which records the content different from the specific content onto the one hard disk. Thereafter, the process is ended.

The recording operation flow according to Embodiment 1 of the present invention has been described with reference to FIGS. 1 and 2.

In the example of FIG. 2, step 201 corresponds to a “step of receiving contents”; step 202 corresponds to a “step of identifying a content among the contents as a specific content satisfying specific conditions”; and step 204 corresponds to a “step of controlling at least two content recording sections among a plurality of content recording sections to record a specific content”.

The example of FIG. 2 shows only one exemplary flow of the recording operation according to according to Embodiment 1 of the present invention. As long as the functions of the above-described steps can be achieved, any flow of the recording operation falls within the scope of the present invention.

According to the present invention, specific contents are mirrored on a plurality of hard disk units, thereby making it possible to protect specific contents from the failure of a hard disk unit. In addition, contents other than specific contents are recorded into a single hard disk unit. Therefore, the capacity of a hard disk unit can be efficiently used as compared to when contents other than specific contents are recorded into all hard disk units.

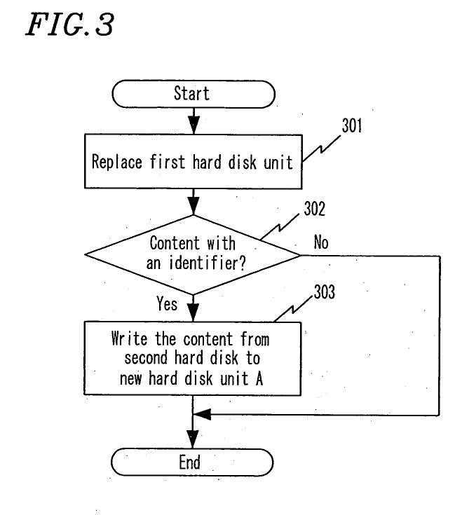

FIG. 3 shows a flow of a content restoring operation according to Embodiment 1 of the present invention. This content restoring operation is carried out by, for example, the content recording apparatus 100. In this case, it is assumed that one of the two hard disk units (the first hard disk unit 104) is broken and the first hard disk unit 104 is replaced with a brand-new hard disk unit A. Note that the second hard disk unit 105 operates normally and the second hard disk unit 105 stores a content to which an identifier is attached. The content with the identifier is, for example, a specific content.

The flow of the content restoring operation will be described step by step with reference to FIGS. 2 and 3.

Step 301: the first hard disk unit 104 is replaced with the hard disk unit A.

Step 302: the recording operation control section 103 searches contents recorded in the second hard disk unit 105 for a content to which an identifier is attached.

When a content with the identifier is found (Yes), the process goes to step 303. When no content with the identifier is found (No), the process is ended.

Step 303: the recording operation control section 103 controls the second hard disk unit 105 and the hard disk unit A in a manner which writes (records) the content with the identifier from the second hard disk unit 105 into the hard disk unit A. Thereafter, the process is ended.

The content with the identifier is a specific content. Therefore, by writing the specific content into the hard disk unit A, the content is restored in the hard disk unit A.

In the flow of the content restoring operation according to Embodiment 1 of the present invention, all contents recorded in the second hard disk unit 105 may be examined before a content with an identifier is written into the hard disk unit A. Alternatively, contents recorded in the second hard disk unit 105 may be examined on a content-by-content basis. Every time a content with the identifier is found, the content may be written into the hard disk unit A.

The reason why the first hard disk unit 104 is replaced is not limited to the failure of the first hard disk unit 104. For example, when no space remains in the first hard disk unit 104, the first hard disk unit 104 may be replaced with a high-capacity hard disk unit.

An identifier may be attached to each content. Alternatively, identifiers may be managed with management information recorded in each hard disk unit.

According to the present invention, a specific content is recorded into a plurality of hard disk units. Therefore, examples of appropriate specific contents include, but are not limited to, precious contents (e.g., a record of the growth of a child, etc.), pay contents, contents having a limitation on the number of times you can copy (e.g., digital broadcast programs, etc.), and the like. Examples of a content different from a specific content, which are not mirrored), include, but are not limited to, temporary recorded contents which would be lost if an accident occurs, and the like.

As described above, the user utilizes the content specifying section 107 to arbitrarily specify a content as a specific content among the received contents.

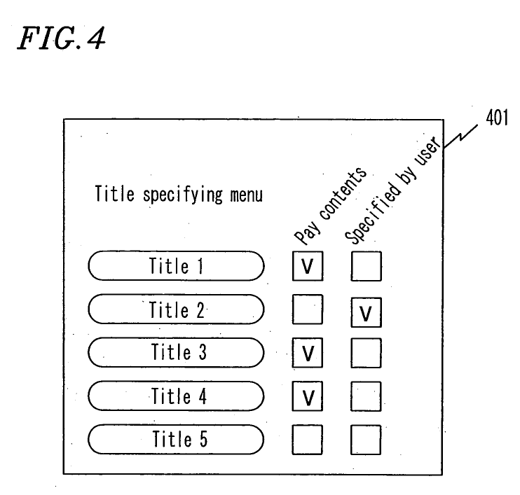

FIG. 4 shows a display screen 401 included in the content specifying section 107. The display screen 401 displays a title specifying menu.

The title specifying menu includes title 1 to title 5, pay content checkboxes corresponding to title 1 to title 5, and user specifying checkboxes corresponding to title 1 to title 5.

For example, the user arbitrarily selects a title from title 1 to title 5, and uses a remote control unit (not shown) from outside of the content recording apparatus 100 to operate the content specifying section 107, thereby checking a user specifying checkbox corresponding to the selected title. In this manner, the user arbitrarily specifies a title as a specific content. For example, the user arbitrarily selects a title from title 1 to title 5 by pushing a button (not shown) provided on the content recording apparatus 100. The user pushes the button once more to check a user specifying checkbox corresponding to the selected title.

For example, pay content checkboxes corresponding to title 1, title 3, and title 4 are prechecked. For example, the user may select and check a user specifying checkbox corresponding to title 2 from title 2 and title 5. The checked user specifying checkbox indicates that title 2 is a content precious to the user.

(Embodiment 2)

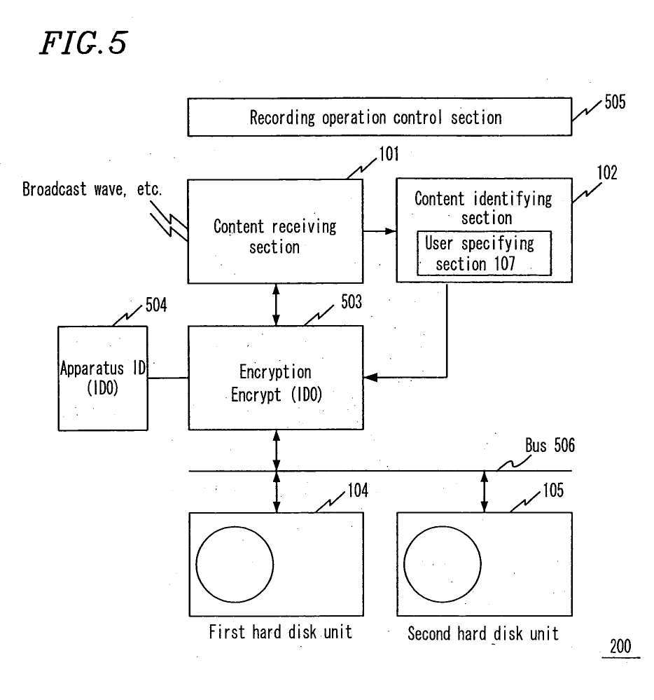

FIG. 5 shows a configuration of a content recording apparatus 200 according to Embodiment 2 of the present invention.

In FIG. 5, the same parts as those of the content recording apparatus 100 of FIG. 1 are referenced by the same reference numerals and will not be explained in detail.

The content recording apparatus 200 comprises a content receiving section 101, a content identifying section 102, an encryption section 503, an apparatus ID storing section 504, a recording operation control section 505, a first hard disk unit 104, a second hard disk unit 105, a bus 506, and a user specifying section 107.

The encryption section 503 encrypts at least one content among received contents. The at least one content is, for example, a specific content. The encryption section 503 transmits the encrypted content to the first hard disk unit 104 and the second hard disk unit 105.

The apparatus ID storing section 504 stores apparatus ID information for specifying the content recording apparatus 200. The apparatus ID information may be, for example, a serial number assigned to the content recording apparatus 200. The encryption section 503 encrypts a specific content using the apparatus ID information as key information for encryption or as a portion of the key information.

The recording operation control section 505 controls the components of the content recording apparatus 200. The encryption section 503, the first hard disk unit 104, and the second hard disk unit 105 are connected to the bus 506.

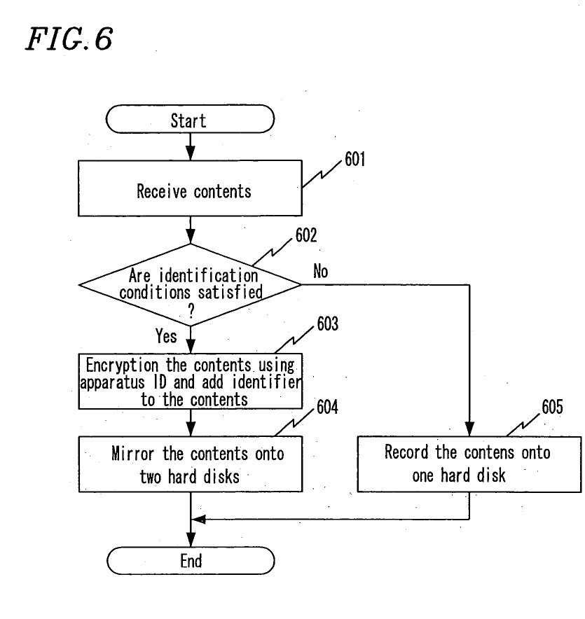

FIG. 6 shows a flow of the recording operation according to Embodiment 2 of the present invention. This flow of the recording operation is carried out by, for example, the content recording apparatus 200.

Hereinafter, the recording operation flow will be described step by step with reference to FIGS. 5 and 6.

Step 601: the content receiving section 101 receives contents.

Step 602: the content identifying section 102 determines whether or not each of the received contents satisfies identification conditions (specific conditions), in order to identify a specific content among the received contents.

When a content satisfies the identification conditions (Yes), the content identifying section 102 identifies the content as the specific content. The process goes to step 603. When it is determined that a content does not satisfy the identification conditions (No), the content identifying section 102 identifies the content as a content different from the specific content. The process goes to step 605.

Step 603: the encryption section 503 encrypts the specific content using the apparatus ID information stored in the apparatus ID storing section 504. The recording operation control section 505 attaches an identifier to the specific content.

Step 604: the recording operation control section 505 controls the first hard disk unit 104 and the second hard disk unit 105 in a manner such that the encrypted specific content with the identifier is mirrored. Thereafter, the process is ended.

Step 605: the recording operation control section 505 controls one of the first hard disk unit 104 and the second hard disk unit 105 in a manner which records a content different from the specific content into the one hard disk. Thereafter, the process is ended.

According to the present invention, the contents recorded in the hard disk unit are encrypted using the apparatus ID information for identifying the content recording apparatus 200. Therefore, even if the hard disk recording the contents is removed and the contents are read out by a personal computer, the contents cannot be decrypted. Also, even if the hard disk is mounted into a content recording apparatus B which is different from the content recording apparatus 200 and the contents are read out, the contents cannot be decrypted. This is because the apparatus ID information of the content recording apparatus 200 is different from the apparatus ID information of the content recording apparatus B. Therefore, the contents can be protected from illegal copying.

Note that the content recording apparatus 200 can be used to restore contents in a manner similar to that of the contents restoring operation described with reference to FIG. 3. Therefore, a flow of the contents restoring operation according to Embodiment 2 of the present invention will not be explained.

Note that encrypted contents are protected by apparatus ID information according to Embodiment 2 of the present invention, though the encrypted contents can be copied into other hard disk units. Therefore, a content recording apparatus is preferably configured such that apparatus ID information cannot be easily recognized by the user in order to prevent illegal use.

Although only specific contents are encrypted in Embodiment 2 of the present invention, contents to be encrypted are not limited to specific contents. All received contents may be encrypted and recorded onto hard disks.

(Embodiment 3)

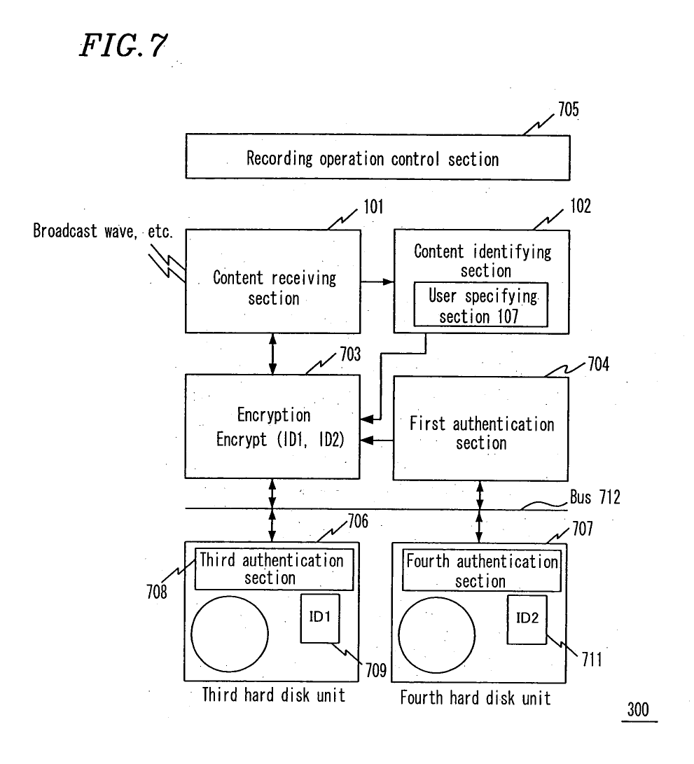

FIG. 7 shows a configuration of a content recording apparatus 300 according to Embodiment 3 of the present invention.

In FIG. 7, the same parts as those of the content recording apparatus 100 of FIG. 1 are referenced by the same reference numerals and will not be explained in detail.

The content recording apparatus 300 comprises a content receiving section 101, a content identifying section 102, an encryption section 703, a third hard disk unit 706, a fourth hard disk unit 707, a first authentication section 704, a recording operation control section 705, a bus 712, and a user specifying section 107.

The encryption section 703 encrypts at least one content among received contents. The at least one content is, for example, a specific content. The encryption section 703 transmits the encrypted content to the third hard disk unit 706 and the fourth hard disk unit 707.

The encryption section 703 may decrypt encrypted information recorded in a hard disk unit.

The third hard disk unit 706 and the fourth hard disk unit 707 are configured to record contents. The third hard disk unit 706 and the fourth hard disk unit 707 are each, for example, a hard disk having a spindle.

The third hard disk unit 706 comprises a magnetic disk for recording contents, a third authentication section 708, and a first device ID storing section 709. The first device ID storing section 709 stores first device ID information having a value “ID1”. The first device ID information is used to encrypt information.

The fourth hard disk unit 707 comprises a magnetic disk for recording contents, a fourth authentication section 710, and a second device ID storing section 711. The second device ID storing section 711 stores second device ID information having a value “ID2”. The second device ID information is used to encrypt information.

The first authentication section 704 performs authentication for the third hard disk unit 706 and the fourth hard disk unit 707. Based on the result of the authentication, the recording operation control section 705 transfers at least one piece of device ID information from at least one of the third hard disk unit 706 and the fourth hard disk unit 707 to the encryption section 703. For example, the first authentication section 704 performs authentication for the third hard disk unit 706 between the first authentication section 704 and the third authentication section 708, and performs authentication for the fourth hard disk unit 707 between the first authentication section 704 and the fourth authentication section 710. When the third hard disk unit 706 is successfully authenticated, the recording operation control section 705 transfers the first device ID information from the third hard disk unit 706 to the encryption section 703.

Generally, apparatuses are authenticated using their own IDs or encrypted codes. After authentication, a temporary key called a “session key” is generated so that encryption communication is established between the authenticated apparatuses.

The recording operation control section 705 controls the components of the content recording apparatus 300. The function of the recording operation control section 705 will be described in detail below.

The encryption section 703, the first authentication section 704, the third hard disk unit 706, and the fourth hard disk unit 707 are connected to the bus 712.

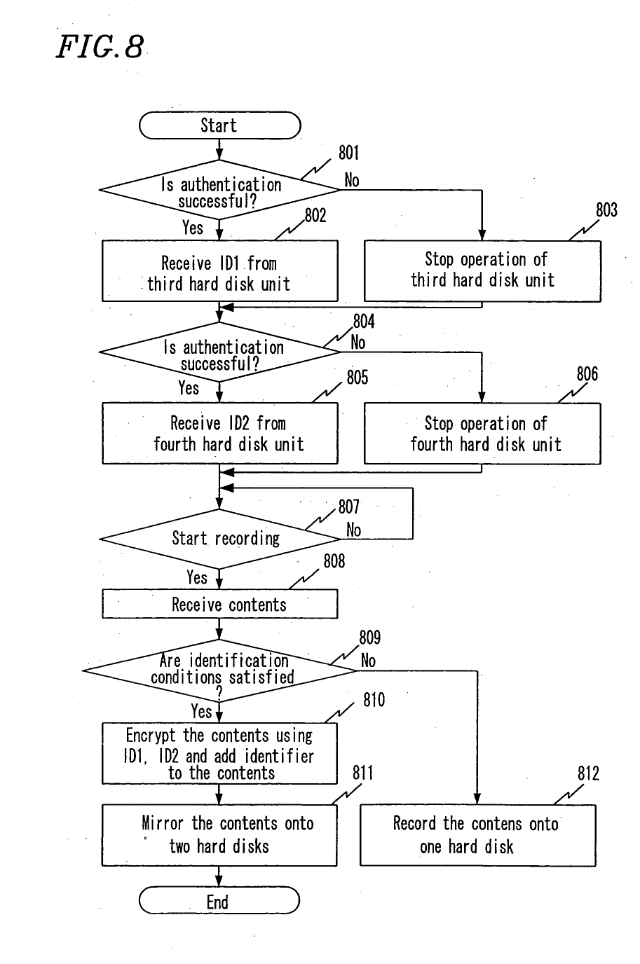

FIG. 8 shows a flow of a recording operation according to Embodiment 3 of the present invention. The flow of the recording operation is carried out by, for example, the content recording apparatus 300.

Hereinafter, the flow of the recording operation will be described step by step with reference to FIGS. 7 and 8.

Step 801: the first authentication section 704 performs authentication for the third hard disk unit 706 between the first authentication section 704 and the third authentication section 708, and determines whether or not the authentication of the third hard disk unit 706 is successful.

When it is determined that the third hard disk unit 706 is successfully authenticated (Yes), the process goes to step 802. When it is determined that the third hard disk unit 706 is not successfully authenticated (No), the process goes to step 803.

Step 802: the encryption section 703 uses the session key to safely receive the first device ID information stored in the first device ID storing section 709 of the third hard disk unit 706. Thereafter, the process goes to step 804.

Step 803: from then on, the recording operation control section 705 stops the operation for the third hard disk unit 706. Thereafter, the process goes to step 804.

Step 804: the first authentication section 704 performs authentication for the fourth hard disk unit 707 between the first authentication section 704 and the fourth authentication section 710, and determines whether or not the authentication of the fourth hard disk unit 707 is successful.

When it is determined that the fourth hard disk unit 707 is successfully authenticated (Yes), the process goes to step 805. When it is determined that the fourth hard disk unit 707 is not successfully authenticated (No), the process goes to step 806.

Step 805: the encryption section 703 uses the session key to safely receive the second device ID information stored in the second device ID storing section 711 of the fourth hard disk unit 707. Thereafter, the process goes to step 807.

Step 806: from then on, the recording operation control section 705 stops the operation for the fourth hard disk unit 707. Thereafter, the process goes to step 807.

Step 807: the recording operation control section 705 starts recording contents.

Step 808: the content receiving section 101 receives contents.

Step 809: the content identifying section 102 determines whether or not each of the received contents satisfies identification conditions (specific conditions), in order to identify a specific content among the received contents.

For example, the content identifying section 102 determines whether or not each of the received contents contains copy right information, in order to identify a content containing copy right information (a content having a limitation on the number of time you can copy) among the received contents.

For example, when it is determined that a content among the received contents contains copy right information (with a limitation on the number of times you can copy) (Yes), the content identifying section 102 identifies the content as a specific content. The process goes to step 810. When it is determined that a content among the received contents does not contain copy right information (with no limitation on the number of times you can copy) (No), the content identifying section 102 identifies the content as a content different from a specific content. The process goes to step 812.

Step 810: the encryption section 703 uses the value “ID1” of the first device ID information and the value “ID2” of the second device ID information to encrypt the specific content. The recording operation control section 705 attaches an identifier indicating mirror recording to the specific content.

Step 811: the recording operation control section 705 controls the third hard disk unit 706 and the fourth hard disk unit 707 in a manner such that the encrypted specific content with the identifier is mirrored. Thereafter, the process is ended.

Step 812: the recording operation control section 705 controls one of the third hard disk unit 706 and the fourth hard disk unit 707 in a manner which records a content different from the specific content. The content different from the specific content is recorded into only one of the third hard disk unit 706 and the fourth hard disk unit 707. Therefore, a smaller recording capacity is required compared to when the content different from the specific content is recorded into both of the third hard disk unit 706 and the fourth hard disk unit 707. Thereafter, the process is ended.

In the flow of the recording operation described with reference to FIG. 8, contents are received after authentication. However, the timing of receiving contents is not limited to after authentication. Contents may be continuously received irrespective of the timing of authentication.

As described above, in Embodiment 3 of the present invention, the specific content is a copying-limited content. However, the specific content is not limited to a copying-limited content. The specific content may be, for example, a content specified by the user or a pay content.

In Embodiment 3 of the present invention, the value “ID1” is different from the value “ID2”. In this case, both the value “ID1” and the value “ID2” are used as key information to encrypt contents, and the encrypted contents is mirrored. Therefore, for example, even if the third hard disk unit 706 is detached from the content recording apparatus 300 and is mounted into another content recording apparatus B (not shown), advantageously the encrypted contents are not restored or reproduced.

However, if the third hard disk unit 706 is broken so that the value “ID1” is not read out, contents mirrored in the fourth hard disk unit 707 can no longer be retrieved. To avoid such a situation, a hard disk unit is desirably configured such that the device ID information can be electrically read out to the greatest possible even if the mechanism is broken, and the device ID storing section can be easily detached from the broken hard disk unit and mounted into a new hard disk unit. The detachment of the device ID storing section will be described below.

The value “ID1” and the value “ID2” are not necessarily different from each other. The same value (the value “ID1”=the value “ID2”) may be assigned to a plurality of hard disk units in the content recording apparatus 300. In this case, for example, when the broken third hard disk unit 706 is removed from the content recording apparatus 300 and is mounted into a content recording apparatus B, contents can be reproduced if the device ID information can be read out from the fourth hard disk unit 707.

In this case, however, by illegally removing a specific hard disk unit from the content recording apparatus 300 and mounting it into the content recording apparatus B, contents can be restored and copied any number of times. This situation is inappropriate for copying-limited contents. To avoid this, for example, apparatus ID information and device ID information need to be combined to generate key information such that contents are not restored in the content recording apparatus B, as described in Embodiment 2 of the present invention with reference to FIG. 5. Since a plurality of hard disk units need to have device ID information having the same value, the device ID information needs to be managed.

The encryption section 703 may encrypt contents using both “ID1” and “ID2”, while the encryption section 703 may decrypt the contents using one of “ID1” and “ID2” which permits decryption. In this case, it is not necessary to store the same value of device ID information in all hard disk units in the content recording apparatus 300, i.e., device ID information may be freely assigned to each hard disk unit. However, in order to prevent an illegal data restore operation, for example, apparatus ID information and device ID information need to be combined to generate key information such that contents are not restored in the content recording apparatus B, as described in Embodiment 2 of the present invention with reference to FIG. 5.

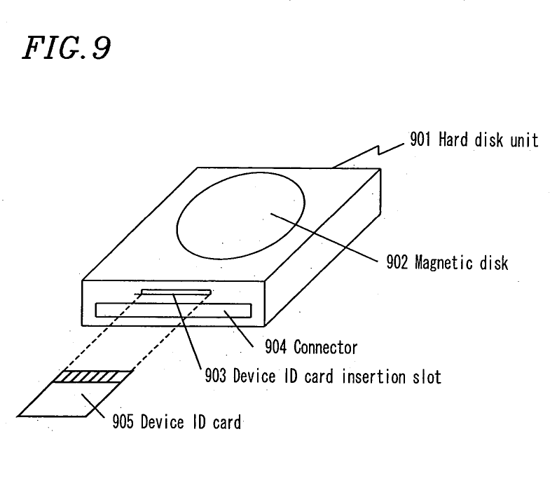

FIGS. 9 to 11 show another exemplary hard disk unit according to Embodiment 3 of the present invention.

Hereinafter, this exemplary hard disk unit according to Embodiment 3 of the present invention will be described with reference to FIGS. 9 to 11.

FIG. 9 shows a configuration of a hard disk unit 901 according to Embodiment 3 of the present invention.

The hard disk unit 901 is configured to be detachable from the content recording apparatus 300.

The hard disk unit 901 comprises a magnetic disk 902 for recording encrypted information and a connector 904 for receiving recorded data (contents). In addition, the hard disk unit 901 is provided with a device ID card insertion slot 903, which accommodates a device ID card 905.

The device ID card 905 is configured to be detachable from the hard disk unit 901. The device ID card 905 stores device ID information for encryption.

For example, the hard disk unit 901 is mounted into the content recording apparatus 300. The device ID information is stored in the device ID card 905. The device ID card 905 is detachable from the hard disk unit 901. Therefore, even if the hard disk unit 901 is broken and is replaced with a new hard disk unit C, the user can easily transfer the device ID information to the hard disk unit C. As a result, mirrored contents can be restored.

Note that when the device ID information is stored in the device ID card 905, the device ID card 905 needs to be configured such that the device ID information cannot be altered by the user.

The device ID card 905 may have functions corresponding to the third authentication section 708 and the fourth authentication section 710.

Contents cannot be decrypted from the hard disk unit 901 detached from the content recording apparatus 300. This is because the device ID card 905 has been transferred into the new hard disk unit.

The content recording apparatus 300 may be configured to require both the value “ID1” and the value “ID2” in order to decrypt contents.

Note that the shape of the device ID card 905 is not limited to a card. The device ID card 905 may be in any shape as long as it is configured to be detachable from the hard disk apparatus 300 and it can store device ID information for encryption.

Another exemplary content recording apparatus 300 has been described with reference to FIGS. 7 and 9.

In the example of FIGS. 7 and 9, the hard disk unit 901 corresponds to a “hard disk apparatus”; the magnetic disk 902 corresponds to a “hard disk for recording encrypted information”; the device ID card 905 corresponds to a “storing section for storing ID information for encryption, the storing section being configured to be detachable from a hard disk apparatus”; the content recording apparatus 300 corresponds to a “main body”; the encryption section 703 corresponds to an “encryption/decryption section for encrypting information to be recorded onto a hard disk or decrypting encrypted information recorded on a hard disk”. However, the example of FIGS. 7 and 9 shows only one exemplary configuration of the content recording apparatus 300 according to according to Embodiment 3 of the present invention. As long as the functions of the above-described sections can be achieved, a content recording apparatus having any configuration falls within the scope of the present invention. For example, the functions of the above-described sections may be implemented either as hardware or as software, or as a combination of hardware and software.

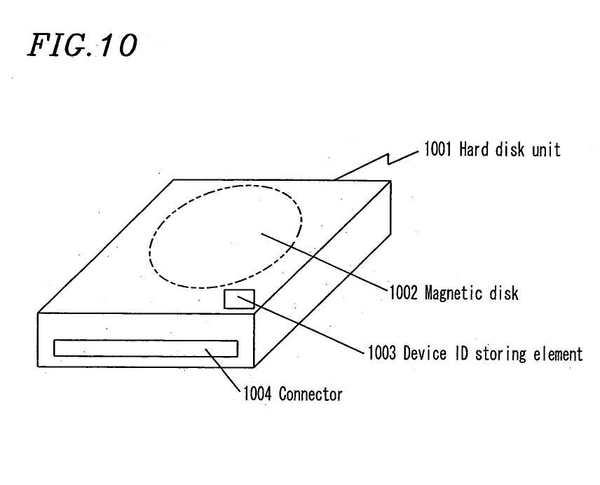

FIG. 10 shows a hard disk unit 1001 according to Embodiment 3 of the present invention.

The hard disk unit 1001 is configured to be detachable from the content recording apparatus 300.

The hard disk unit 1001 comprises a magnetic disk 1002 for recording encrypted information, a connector 1004 for receiving recorded data (contents), and a device ID storing element 1003 which is configured to store device ID information for encryption. The device ID storing element 1003 is, for example, a PROM (semiconductor storage element).

The hard disk unit 1001 does not particularly require a connector for a memory card. However, importantly, the hard disk unit 1001 needs to be configured such that contents stored in the device ID storing element 1003 can be read out via a connector when the hard disk unit 1001 is broken. In addition, when device ID information is recorded in the device ID storing element 1003, the device ID storing element 1003 needs to be configured such that the device ID information cannot be altered by the user.

The user cannot detach or remove the device ID storing element 1003 from the hard disk unit 1001. Therefore, when the hard disk unit 1001 is broken, for example, the hard disk unit 1001 needs to be sent back to a factory or a serviceman needs to read out ID using a special apparatus and set the ID in a new hard disk unit.

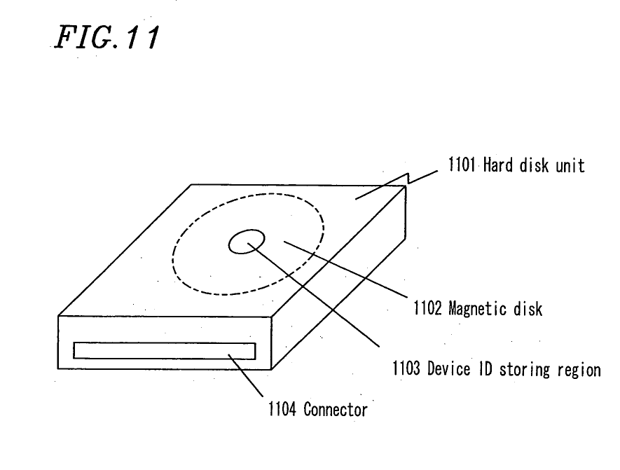

FIG. 11 shows a configuration of a hard disk unit 1101 according to Embodiment 3 of the present invention.

The hard disk unit 1101 is configured to be detachable from the content recording apparatus 300.

The hard disk unit 1001 comprises a magnetic disk 1102 for recording encrypted information and a connector 1104 for receiving recorded data (contents).

The magnetic disk 1102 has a device ID storage region 1103 which is configured to store device ID information for encryption.

When device ID information is stored in the device ID storage region 1103, the device ID storage region 1103 needs to be configured such that the device ID information cannot be altered by the user.

The hard disk unit 1101 does not require an additional element for storing device ID information. However, when the hard disk unit 1101 is broken, the device ID information can no longer be read out. Therefore, in this example, the issuance condition of device ID information for a hard disk unit needs to be managed for each content recording apparatus. In addition, a new hard disk unit for replacement needs to be shipped after device ID information is set into the hard disk unit in a factory.

Contents can be restored using the content recording apparatus 300 in a manner similar to that of the contents restoring operation described with reference to FIG. 3. Therefore, the contents restoring operation according to Embodiment 3 of the present invention will not be explained.

(Embodiment 4)

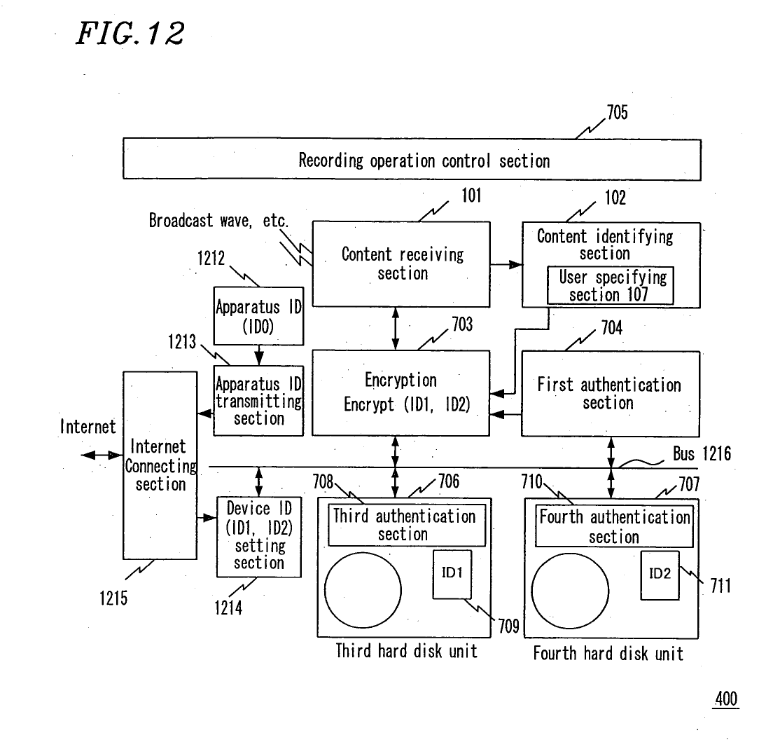

FIG. 12 shows a configuration of a content recording apparatus 400 according to Embodiment 4 of the present invention.

In FIG. 12, the same parts as those of the content recording apparatus 100 of FIG. 1 and the content recording apparatus 300 of FIG. 7 are referenced by the same reference numerals and will not be explained in detail.

The content recording apparatus 400 comprises a content receiving section 101, a content identifying section 102, an encryption section 703, a third hard disk unit 706, a fourth hard disk unit 707, a first authentication section 704, a recording operation control section 705, a device ID storing section 1212, a device ID transmitting section 1213, a device ID setting section 1214, an Internet connecting section 1215, a bus 1216, and a user specifying section 107.

The device ID storing section 1212 stores device ID information for specifying the content recording apparatus 400. The device ID information may be, for example, a serial number assigned to the content recording apparatus 400.

The device ID transmitting section 1213 encrypts the device ID information and transmits the encrypted device ID information to an external network.

The Internet connecting section 1215 connects the connecting section 400 to the external network in order to obtain information. For example, the Internet connecting section 1215 is connected via the Internet to a server which manages device ID information.

The device ID setting section 1214 sets device ID information to information obtained from an external network. For example, the device ID setting section 1214 sets the device ID information of a replaced hard disk unit to the encrypted device ID information obtained from the Internet. The device ID setting section 1214 sets only device ID information, which has been encrypted in a predetermined manner and transmitted via the Internet, into a hard disk unit.

Note that the device ID setting section 1214 may be, for example, application software. The device ID setting section 1214 may also be implemented as hardware.

According to the content recording apparatus 400, device ID information is used to identify a content recording apparatus, device ID information required for each content recording apparatus is obtained via a network, and device ID information can be set into a new hard disk unit by a device ID setting section.

Note that the content recording apparatus 400 can be used to restore contents in a manner similar to that of the contents restoring operation described with reference to FIG. 3. Therefore, a flow of the contents restoring operation according to Embodiment 4 of the present invention will not be explained.

According to Embodiment 4 of the present invention, it is possible to compensate for the drawback (the user cannot move device ID information) of the above-described embodiment (FIG. 10), in which an ID storing element (semiconductor) is incorporated into a hard disk unit and the above-described embodiment (FIG. 11), in which a device ID storage region is allocated in a predetermined region on a magnetic disk.

In order to avoid illegal use via a network, apparatus ID information needs to be encrypted when it is transmitted to a content recording apparatus. Device ID information also needs to be encrypted when it is received or when it is used in applications requiring device ID information. In addition, the issuance of device ID information needs to be managed.

In order to improve security, for example, a new hard disk unit, in which device ID information is permitted to be set, is sent to the user only when a broken hard disk unit is returned.

Embodiments 1 to 4 of the present invention have been described with reference to the accompanying figures.

According to Embodiments 1 to 4 of the present invention, a specific content is recorded into at least two content recording sections. Therefore, even if one of the at least two content recording sections (e.g., a hard disk unit) recording the specific content is broken, it is possible to prevent the specific content from being lost from a content recording apparatus.

According to Embodiments 1 to 4 of the present invention, it is possible for the user to back up specific contents (e.g., precious contents, pay contents, etc.) on a day-to-day basis without any particular backup operations. As a result, it is possible to prevent specific contents from being lost due to the failure of a hard disk, and prevent the illegal use of specific contents.

According to Embodiments 1 to 4 of the present invention, when a new hard disk is prepared, it is possible to record and restore specific contents onto the new hard disk. The recorded contents are encrypted using ID information which cannot be altered by general users, thereby making it possible to prevent the illegal use of the specific contents using a personal computer or the like.

According to Embodiments 1 to 4 of the present invention, a storing section for storing ID information for encryption is configured to be detachable from a hard disk apparatus. Therefore, when a hard disk apparatus is broken and a new hard disk apparatus is used, the user can easily move ID information to the new hard disk apparatus and restore mirrored contents.

The content recording apparatus of the present invention is useful as a hard disk recorder which records digital broadcast contents, a recording apparatus which employs a recording medium (e.g., an optical disc or the like other than a hard disk), or the like. By taking advantage of a feature of the present invention such that illegal copying can be prevented without losing precious data, the content recording apparatus of the present invention can be applied to a data storage apparatus for a computer, for example.

Although certain preferred embodiments have been described herein, it is not intended that such embodiments be construed as limitations on the scope of the invention except as set forth in the appended claims. Various other modifications and equivalents will be apparent to and can be readily made by those skilled in the art, after reading the description herein, without departing from the scope and spirit of this invention. All patents, published patent applications and publications cited herein are incorporated by reference as if set forth fully herein.

1. A content recording apparatus, comprising:
a content receiving section for receiving contents;
a content identifying section for identifying a specific content satisfying specific conditions among the received contents;
a plurality of content recording sections configured to record the received contents; and
a recording control section for controlling at least two of the plurality of content recording sections to record the specific content.

2. A content recording apparatus according to claim 1, wherein the recording control section controls one of the plurality of content recording sections to record a content different from the specific content.

3. A content recording apparatus according to claim 1, wherein each of the plurality of content recording sections is a hard disk having a spindle.

4. A content recording apparatus according to claim 1, wherein the recording control section controls a specific content recording section among the plurality of content recording sections but other than the at least two content recording sections, and one of the at least two content recording sections, to record the specific content recorded in the one of the at least two content recording sections into the specific content recording section.

5. A content recording apparatus according to claim 1, further comprising a content specifying section for arbitrarily specifying a content among the received contents.

6. A content recording apparatus according to claim 5, wherein the specific content is the arbitrarily specified content.

7. A content recording apparatus according to claim 1, wherein the specific content is a pay content including billing information.

8. A content recording apparatus according to claim 1, wherein the specific content is a copying-limited content including copying limitation information.

9. A content recording apparatus according to claim 1, further comprising an encryption section for encrypting at least one content among the received contents.

10. A content recording apparatus according to claim 9, wherein the at least one content is the specific content.

11. A content recording apparatus according to claim 9, further comprising:
an ID information storing section for storing apparatus ID information for specifying the content recording apparatus,
wherein the encryption section encrypts the at least one content using the apparatus ID information.

12. A content recording apparatus according to claim 9, wherein each of the plurality of content recording sections further comprises an ID information storing section for storing ID information for encryption, and
the encryption section encrypts the at least one content using at least one of the plurality of pieces of ID information.

13. A content recording apparatus according to claim 12, wherein the plurality of pieces of ID information have the same value as one another.

14. A content recording apparatus according to claim 12, wherein the plurality of pieces of ID information have different values from one another, and
the encryption section encrypts the at least one content using one of the plurality of pieces of ID information.

15. A content recording apparatus according to claim 12, further comprising:
an authentication section for performing authentication for the plurality of content recording sections,
wherein the recording control section transfers ID information of the plurality of pieces of ID information corresponding to the at least one content recording section from at least one of the plurality of content recording sections to the encryption section based on a result of the authentication.

16. A content recording apparatus according to claim 12, wherein each of the plurality of ID information storing sections is a card configured to be detachable from the content recording section.

17. A content recording apparatus according to claim 12, wherein each of the plurality of ID information storing sections is a semiconductor element.

18. A content recording apparatus according to claim 12, wherein each of the plurality of ID information storing section has a specific storage region, the region being prohibited from recording by the user, and
each of the plurality of pieces of ID information is stored in the specific storage region.

19. A content recording apparatus according to claim 12, further comprising:
a connecting section for connecting the content recording apparatus to an external network to obtain information via the external network; and
an ID information setting section for setting each of the plurality of pieces of ID information to the information obtained via the external network.

20. A content recording apparatus according to claim 19, further comprising:
an ID information transmitting section for encrypting the plurality of pieces of ID information and transmitting the plurality of pieces of encrypted ID information to the external network.

21. A method for recording contents into a plurality of content recording sections configured to record contents, comprising the steps of:
(a) receiving contents;
(b) identifying a specific content satisfying specific conditions among the received contents; and
(c) controlling at least two of the plurality of content recording sections to record the specific content.

22. A method according to claim 21, wherein the step of (c) comprises controlling one of the plurality of content recording sections to record a content different from the specific content.

23. A method according to claim 21, wherein each of the plurality of content recording sections is a hard disk having a spindle.

24. A method according to claim 21, wherein the step of (c) comprises controlling a specific content recording section among the plurality of content recording sections but other than the at least two content recording sections, and one of the at least two content recording sections, to record the specific content recorded in the one of the at least two content recording sections into the specific content recording section.

25. A method according to claim 21, further comprising arbitrarily specifying a content among the received contents.

26. A method according to claim 25, wherein the specific content is the arbitrarily specified content.

27. A method according to claim 21, wherein the specific content is a pay content including billing information.

28. A method according to claim 21, wherein the specific content is a copying-limited content including copying limitation information.

29. A method according to claim 21, further comprising encrypting at least one content among the received contents.

30. A method according to claim 29, wherein the at least one content is the specific content.

31. A method according to claim 29, further comprising:
storing apparatus ID information for specifying a content recording apparatus comprising the plurality of content recording sections,
wherein the encrypting step comprises encrypting the at least one content using the apparatus ID information.

32. A method according to claim 29, wherein each of the plurality of content recording sections further comprises an ID information storing section for storing ID information for encryption, and
the encrypting step comprises encrypting the at least one content using at least one of the plurality of pieces of ID information.

33. A method according to claim 32, wherein the plurality of pieces of ID information have the same value as one another.

34. A method according to claim 32, wherein the plurality of pieces of ID information have different values from one another, and
the encrypting step comprises encrypting the at least one content using one of the plurality of pieces of ID information.

35. A method according to claim 32, further comprising:
performing authentication for the plurality of content recording sections,
wherein the step of (c) comprises transferring ID information of the plurality of pieces of ID information corresponding to the at least one content recording section from at least one of the plurality of content recording sections to an encryption section for performing the encrypting step, based on a result of the authentication.

36. A method according to claim 32, wherein each of the plurality of ID information storing sections is a card configured to be detachable from the content recording section.

37. A method according to claim 32, wherein each of the plurality of ID information storing sections is a semiconductor element.

38. A method according to claim 32, wherein each of the plurality of ID information storing section has a specific storage region, the region being prohibited from recording by the user, and
each of the plurality of pieces of ID information is stored in the specific storage region.

39. A method according to claim 32, further comprising:
obtaining information via the external network; and
setting each of the plurality of pieces of ID information to the information obtained via the external network.

40. A method according to claim 39, further comprising:
encrypting the plurality of pieces of ID information and transmitting the plurality of pieces of encrypted ID information to the external network.

41. A hard disk apparatus, comprising:
a hard disk for recording encrypted information; and
a storing section for storing ID information for encryption,
wherein the storing section is configured to be detachable from the hard disk apparatus.

42. A hard disk apparatus according to claim 41, wherein the hard disk apparatus is configured to be detachable from a main body, and
the main body comprises an encryption/decryption section for encrypting information to be recorded into the hard disk or decrypting encrypted information recorded in the hard disk.
